(19) United States
(12) Patent Application Publication
(10) Pub. No.: US 2025/0115217 A1
(43) Pub. Date: Apr. 10, 2025

(54) CONVEYING TRACK FOR TUNNEL-TYPE VEHICLE WASHING MACHINE

(71) Applicant: YIGOLI TECHNOLOGY (HONG KONG) LIMITED, HK (HK)

(72) Inventor: Hengzhi Shi, HK (HK)

(21) Appl. No.: 18/987,028

(22) Filed: Dec. 19, 2024

(51) Int. Cl. B60S 3/00; B60S 3/04

(52) U.S. Cl. CPC B60S 3/004; B60S 3/04

(57) ABSTRACT

Provided is a conveying track for a tunnel-type vehicle washing machine. The conveying track includes a track device arranged in a working area and a spraying assembly for mud and sand removal, where the track device is configured to bear a vehicle and drive the vehicle to move; a bottom spraying assembly is arranged in a middle of the track device to spray water to wash a bottom of the vehicle; and the spraying assembly for mud and sand removal is configured to wash a bottom surface of the working area. The bottom spraying assembly can spray water upwards, and when the vehicle passes a portion above the bottom spraying assembly, the bottom of the vehicle is washed by the bottom spraying assembly. Dirt such as mud and sand at the bottom of the vehicle can be washed off such that the bottom of the vehicle can be cleaned.

### BACKGROUND OF THE PRESENT INVENTION

### Field of Invention

The present disclosure relates to the technical field of vehicle washing machines, and particularly relates to a conveying track for a tunnel-type vehicle washing machine.

### Description of Related Arts

As a highly-efficient and highly-automated vehicle washing apparatus, a tunnel-type vehicle washing machine can rapidly clean a vehicle. Typically designed as a long channel with an internal conveying track, it allows a vehicle to be driven onto the conveying track and then moved along by the conveying track. When the vehicle moves, an outer surface of a vehicle body is cleaned by various nozzles, brushes and other cleaning devices.

However, the existing tunnel-type vehicle washing machines have the following defects: 1. The vehicle cannot be completely cleaned because a bottom of the vehicle cannot be effectively cleaned; and 2. After the cleaning process, dirt such as mud and sand washed off the vehicle will fall on a ground surface beneath the conveying track, such that special personnel is required to clean the ground, resulting in high labor costs.

### SUMMARY OF THE PRESENT INVENTION

An objective of the present disclosure is to provide a conveying track for a tunnel-type vehicle washing machine, so as to solve the defects in the prior art.

The objective of the present disclosure is realized through a technical solution as follows: a conveying track for a tunnel-type vehicle washing machine includes a track device arranged in a working area and a spraying assembly for mud and sand removal. The track device is configured to bear a vehicle and drive the vehicle to move, a bottom spraying assembly is arranged in a middle of the track device to spray water to wash a bottom of the vehicle, and the spraying assembly for mud and sand removal is configured to wash a bottom surface of the working area.

Preferably, the bottom spraying assembly includes a three-way joint and two bottom spraying pipes. One port of the three-way joint is a water inlet, while the other two ports are connected to the two bottom spraying pipes respectively. A plurality of first nozzles are arranged on the bottom spraying pipes to spray water upwards.

Preferably, a grating plate is arranged in the middle of the track device, and the bottom spraying pipes are connected to a grating frame on a periphery of the grating plate by fixed pipe clamps.

Preferably, the spraying assembly for mud and sand removal includes bottom mud and sand washing-off pipes arranged on two sides of the track device. A plurality of second nozzles are arranged on the bottom mud and sand washing-off pipes to spray water downwards. A water-inlet joint is arranged at one end of the bottom mud and sand washing-off pipe.

Preferably, platform components are arranged on the two sides of the track device, and upper-end surfaces of the platform components are flush with an upper-end surface of the track device.

Preferably, the platform component is constructed out of a plurality of platform frame units, and platform plates are arranged at upper ends of the platform frame units.

Preferably, movable casters and a leveling assembly are arranged at a lower end of the track device.

Preferably, the leveling assembly includes a screw rod, a track frame supporting member and a locking nut. Both the track frame supporting member and the locking nut are in threaded connection to the screw rod, and a frame body of the track device is placed on the track frame supporting member.

Preferably, the working area is divided into a parking area, a vehicle washing area and a completion area.

Preferably, an entrance ramp plate and an exit ramp plate are arranged at two ends of the track device respectively.

Beneficial effects of the present disclosure are as follows:

1. According to the present disclosure, when the vehicle is cleaned, the vehicle is driven onto the track device first, and then moved along by the track device. The bottom spraying assembly can spray water upwards, and when the vehicle passes a portion above the bottom spraying assembly, the bottom of the vehicle is washed by the bottom spraying assembly. Dirt such as mud and sand at the bottom of the vehicle can be washed off such that the bottom of the vehicle can be cleaned.

2. After the vehicle is cleaned by the vehicle washing machine, a large amount of mud and sand will be washed off the vehicle and accumulate on the ground of the working area. Then the spraying assembly for mud and sand removal is utilized to wash off the accumulated mud and sand on the ground through clear water sprayed by the spraying assembly for mud and sand removal, and the mud and sand washed off drain into a desilting ditch arranged near the working area such that the dirt such as the mud and sand can be discharged. Thus, the bottom surface of the working area can be cleaned, and the need for manual floor washing can be eliminated.

### BRIEF DESCRIPTION OF THE DRAWINGS

FIG. 1 is a top view of the present disclosure.

FIG. 2 is a side view of the present disclosure.

FIG. 3 is an enlarged view of part A in FIG. 2.

FIG. 4 is a schematic structural diagram of a bottom spraying assembly.

FIG. 5 is a schematic structural diagram of a spraying assembly for mud and sand removal.

FIG. 6 is a schematic structural diagram of a leveling assembly.

FIG. 7 is a schematic structural diagram of a bearing seat.

FIG. 8 is a sectional view of a bearing seat.

FIG. 9 is a schematic structural diagram of a platform frame unit.

In the figures: 1. track device, 2. bottom spraying assembly, 2-1. bottom spraying pipe, 2-2. first nozzle, 2-3. three-way joint, 2-4. fixed pipe clamp, 3. spraying assembly for mud and sand removal, 3-1. bottom mud and sand washing-off pipe, 3-2. second nozzle, 3-3. water-inlet joint, 4. grating plate, 5. platform component, 5-1. platform frame unit, 6. bearing seat, 7. entrance ramp plate, 8. exit ramp plate, 9. movable caster, 10. leveling assembly, 10-1. screw rod, 10-2. track frame supporting member, 10-3. locking nut, and 10-4. leveling foot support.

### DETAILED DESCRIPTION OF THE PREFERRED EMBODIMENT

Technical solutions in examples of the present disclosure will be clearly and completely described below in combination with accompanying drawings herein. Obviously, the described examples are merely some rather than all examples of the present disclosure. All other examples obtained by those of ordinary skill in the art based on examples hereof fall within the scope of protection of the present disclosure.

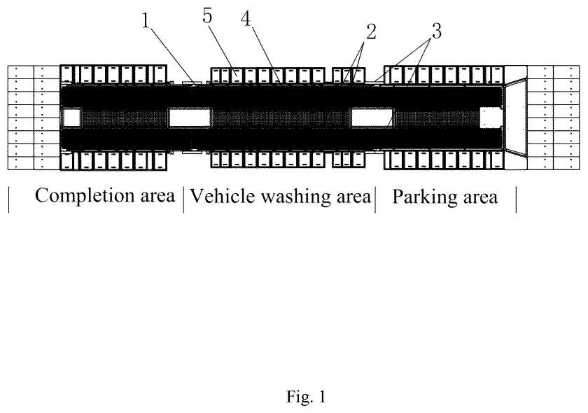

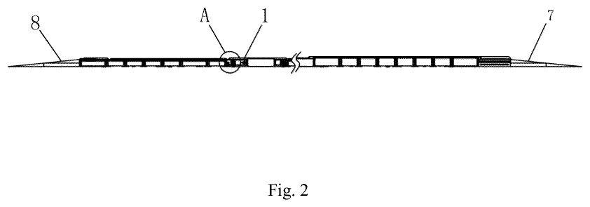

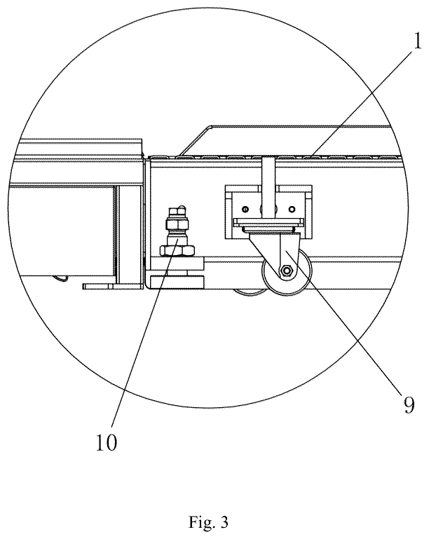

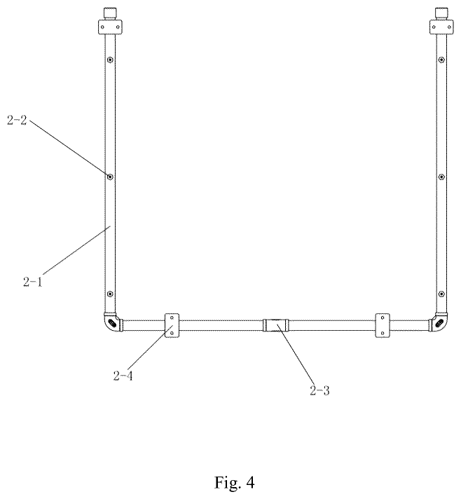

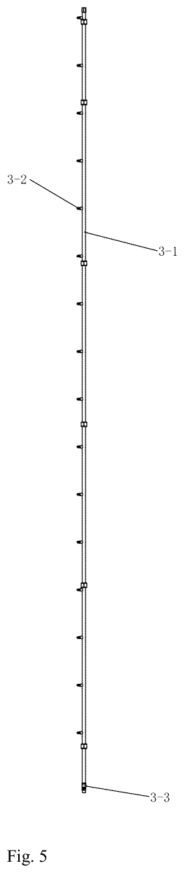

As shown in FIGS. 1-9, a conveying track for a tunnel-type vehicle washing machine includes a track device 1 arranged in a working area and a spraying assembly for mud and sand removal 3. The track device 1 is configured to bear a vehicle and drive the vehicle to move, a bottom spraying assembly 2 is arranged in a middle of the track device 1 to spray water to wash a bottom of the vehicle, and the spraying assembly for mud and sand removal 3 is configured to wash a bottom surface of the working area.

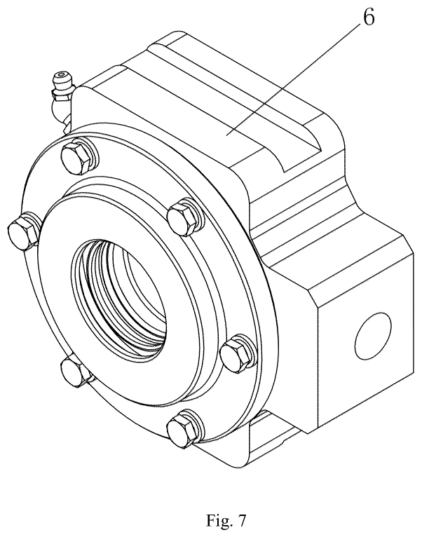

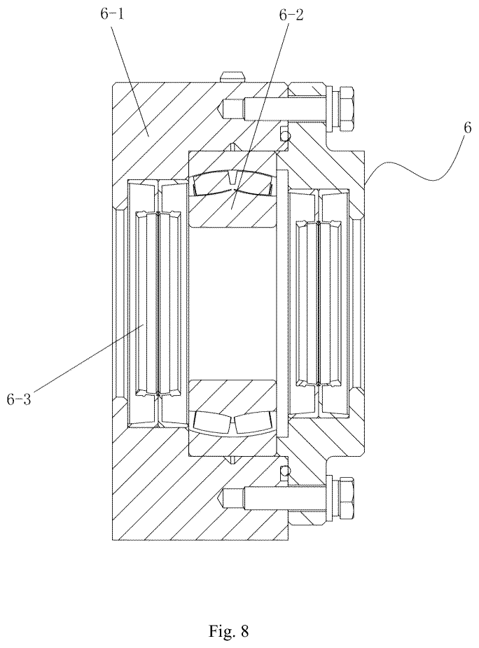

The track device 1 includes two conveying chains arranged left and right. The conveying chains are driven by an electric motor. When a vehicle is parked on the track device, wheels on two sides of the vehicle rest on the respective conveying chains, and movements of the conveying chains drive the vehicle to move. A structure of a bearing seat 6 used in the track device 1 is shown in FIGS. 7 and 8. Shaft seals are arranged on two sides of the bearing seat respectively to seal an internal bearing, preventing the situation that water penetrates the bearing seat 6 to make contact with the bearing.

According to the present disclosure, when the vehicle is cleaned, the vehicle is driven onto the track device 1 first, and then moved along by the track device 1. The bottom spraying assembly 2 can spray water upwards, and when the vehicle passes a portion above the bottom spraying assembly 2, the bottom of the vehicle is washed by the bottom spraying assembly 2. Dirt such as mud and sand at the bottom of the vehicle can be washed off such that the bottom of the vehicle can be cleaned. After the vehicle is cleaned by the vehicle washing machine, a large amount of mud and sand will be washed off the vehicle and accumulate on the ground of the working area. Then the spraying assembly for mud and sand removal 3 is utilized to wash off the accumulated mud and sand on the ground through clear water sprayed by the spraying assembly for mud and sand removal 3, and the mud and sand washed off drain into a desilting ditch arranged near the working area such that the dirt such as the mud and sand can be discharged. Thus, the bottom surface of the working area can be cleaned, and the need for manual floor washing can be eliminated.

The bottom spraying assembly 2 includes a three-way joint 2-3 and two bottom spraying pipes 2-1. One port of the three-way joint 2-3 is a water inlet, while the other two ports are connected to the two bottom spraying pipes 2-1 respectively. A plurality of first nozzles 2-2 are arranged on the bottom spraying pipes 2-1 to spray water upwards. The bottom spraying assembly 2 is of a U-shaped structure as a whole. Water is introduced from the water inlet on the three-way joint 2-3, and then sprayed from each first nozzle 2-2 on the bottom spraying pipes 2-1. The first nozzles 2-2 are fan-shaped, allowing the sprayed water to wash the bottom of the vehicle and wash off the attached mud and sand.

A grating plate 4 is arranged in the middle of the track device 1, and the bottom spraying pipes 2-1 are connected to a grating frame on a periphery of the grating plate 4 by fixed pipe clamps 2-4.

The spraying assembly for mud and sand removal 3 includes bottom mud and sand washing-off pipes 3-1 arranged on two sides of the track device 1. A plurality of second nozzles 3-2 are arranged on the bottom mud and sand washing-off pipes 3-1 to spray water downwards. A water-inlet joint 3-3 is arranged at one end of the bottom mud and sand washing-off pipe 3-1. The bottom mud and sand washing-off pipes 3-1 are straight in shape, with the second nozzles 3-2 sequentially arranged along their length directions. Water is introduced from the water-inlet joint 3-3 at one end of the bottom mud and sand washing-off pipe 3-1, and then sprayed from each second nozzle 3-2 on the bottom mud and sand washing-off pipe 3-1, allowing the sprayed water to wash the ground.

Platform components 5 are arranged on the two sides of the track device 1, and upper-end surfaces of the platform components 5 are flush with an upper-end surface of the track device 1. The platform components 5 are fixed on the ground of the working area to expand a width of the upper end of the track device 1. The expanded width makes a customer feel the same sense of security as washing his or her vehicle on the ground.

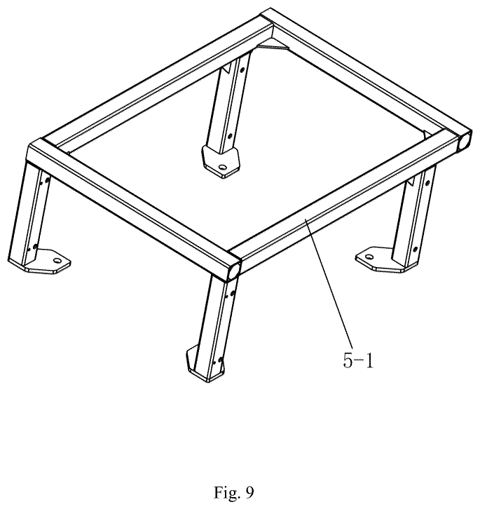

The platform component 5 is constructed out of a plurality of platform frame units 5-1, and platform plates are arranged at upper ends of the platform frame units 5-1. A structure of the platform frame unit 5-1 is shown in FIG. 9.

Additionally, movable casters 9 and a leveling assembly 10 are arranged at a lower end of the track device 1. The movable casters 9 are arranged such that the track device 1 can conveniently move, while the leveling assembly 10 is configured to adjust the horizontal alignment of the track device 1 and improve the adaptability of the bottom of the track device 1 to uneven ground.

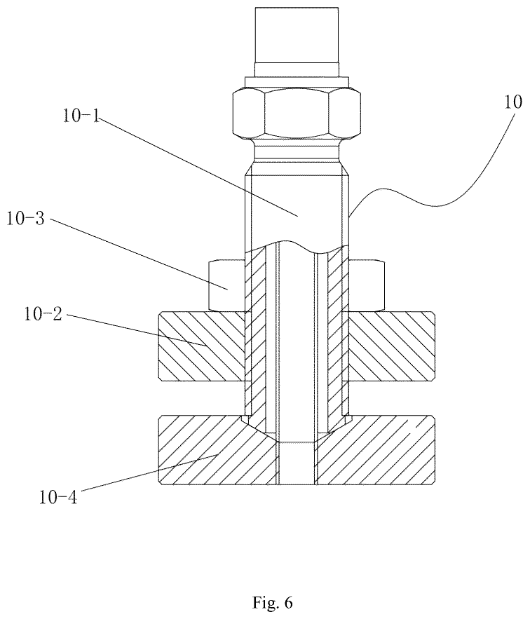

Specifically, a structure of the leveling assembly 10 is shown in FIG. 6. The leveling assembly includes a screw rod 10-1, a track frame supporting member 10-2 and a locking nut 10-3. Both the track frame supporting member 10-2 and the locking nut 10-3 are in threaded connection to the screw rod 10-1, and a frame body of the track device 1 is placed on the track frame supporting member 10-2. A lower end of the screw rod 10-1 is connected to a leveling foot support 10-4, which makes contact with the ground. By rotating the track frame supporting member 10-2, the track frame supporting member 10-2 moves up and down along with the screw rod 10-1 to drive the frame body of the track device 1 to move up and down such that the horizontal alignment of the track device 1 can be adjusted.

In the present disclosure, the working area is divided into a parking area, a vehicle washing area and a completion area. After being driven onto the track device 1, the vehicle stops in the parking area. The track device 1 then moves the vehicle to the vehicle washing area, where an outer surface of a vehicle body is cleaned by various nozzles, brushes and other cleaning devices. Moreover, the bottom of the vehicle is washed by the bottom spraying assembly 2. Upon completion of the cleaning process, the track device 1 moves the vehicle to the completion area, where the vehicle undergoes drying. The vehicle exits the track device 1 after drying.

An entrance ramp plate 7 and an exit ramp plate 8 are arranged at two ends of the track device 1 respectively. Specifically, the entrance ramp plate 7 is arranged at the end of the track device 1 close to the parking area, while the exit ramp plate 8 is arranged at the end of the track device 1 close to the completion area. The entrance ramp plate 7 facilitates the easy entry of the vehicle onto the track device 1, and the exit ramp plate 8 enables the convenient exist of the vehicle from the track device 1.

The present disclosure is not limited to the above optimum embodiment. Anyone can obtain other products in various forms with the motivation of the present disclosure. However. no matter what change is made to its shape or structure. any technical solution identical or similar to that of the present disclosure falls within the scope of protection of the present disclosure.

1. A conveying track for a tunnel-type vehicle washing machine, comprising a track device arranged in a working area and a spraying assembly for mud and sand removal, wherein the track device is configured to bear a vehicle and drive the vehicle to move; a bottom spraying assembly is arranged in a middle of the track device to spray water to wash a bottom of the vehicle; and the spraying assembly for mud and sand removal is configured to wash a bottom surface of the working area.

2. The conveying track for the tunnel-type vehicle washing machine according to claim 1, wherein the bottom spraying assembly comprises a three-way joint and two bottom spraying pipes, one port of the three-way joint is a water inlet, while the other two ports are connected to the two bottom spraying pipes respectively, and a plurality of first nozzles are arranged on the bottom spraying pipes to spray water upwards.

3. The conveying track for the tunnel-type vehicle washing machine according to claim 2, wherein a grating plate is arranged in the middle of the track device, and the bottom spraying pipes are connected to a grating frame on a periphery of the grating plate by fixed pipe clamps.

4. The conveying track for the tunnel-type vehicle washing machine according to claim 1, wherein the spraying assembly for mud and sand removal comprises bottom mud and sand washing-off pipes on two sides of the track device, a plurality of second nozzles are arranged on the bottom mud and sand washing-off pipes to spray water downwards, and a water-inlet joint is arranged at one end of the bottom mud and sand washing-off pipe.

5. The conveying track for the tunnel-type vehicle washing machine according to claim 1, wherein platform components are arranged on the two sides of the track device, and upper-end surfaces of the platform components are flush with an upper-end surface of the track device.

6. The conveying track for the tunnel type-vehicle washing machine according to claim 5, wherein the platform component is constructed out of a plurality of platform frame units, and platform plates are arranged at upper ends of the platform frame units.

7. The conveying track for the tunnel-type vehicle washing machine according to claim 1, wherein movable casters and a leveling assembly are arranged at a lower end of the track device.

8. The conveying track for the tunnel-type vehicle washing machine according to claim 7, wherein the leveling assembly comprises a screw rod, a track frame supporting member and a locking nut, both the track frame supporting member and the locking nut are in threaded connection to the screw rod, and a frame body of the track device is placed on the track frame supporting member.

9. The conveying track for the tunnel-type vehicle washing machine according to claim 1, wherein the working area is divided into a parking area, a washing area and a completion area.

10. The conveying track for the tunnel-type vehicle washing machine according to claim 1, wherein an entrance ramp plate and an exit ramp plate are arranged at two ends of the track device respectively.
